(19) United States
(12) Patent Application Publication
(10) Pub. No.: US 2018/0122026 A1
(43) Pub. Date: May 3, 2018

(54) INDEPENDENT ARTIST MARKETING SYSTEM

(71) Applicant: Rogerla Braden, Sandusky, OH (US)

(72) Inventor: Rogerla Braden, Sandusky, OH (US)

(21) Appl. No.: 15/339,681

(22) Filed: Oct. 31, 2016

(51) Int. Cl. G06Q 50/18; G06Q 20/10

(52) U.S. Cl. CPC G06Q 50/184; G06Q 20/10

(57) ABSTRACT

A method of marketing independent artists from a pool of contestants, that pays contestants a royalty of the shows collections that they participate in.

### FIELD OF INVENTION

The invention relates generally to a business methodology for a talent search show. The show is formatted to allow independent artists to perform original songs and earn higher-than-conventional royalties during their performances. The show will be in accordance with guidelines established by performing rights organizations such as ASCAP, BMI, SESAC. The sub-process for distribution of royalties is unique, as well as the reward sub-process. In the invention's preferred embodiment, the final five artists in each genre category will go on a worldwide tour. This is arranged differently from a conventional talent search show where the artists compete for a single record deal.

### BACKGROUND OF THE INVENTION

Oftentimes, it is difficult for even talented independent artists whose performance level is on par with established artists to “break into” the industry. Oftentimes, the industry is based on interpersonal networking and introductions. Compared to past trends, record labels are not signing artists in the same frequency they used to. The invention's show system gives independent artists that are “ready” the opportunity to be heard by the general public and the opportunity to make lucrative earnings comparable to major artists.

Oftentimes, many independent artists are not familiar with the legal processes necessary to perform, and are unfamiliar with rules and regulations pertaining to copyright and royalties. Oftentimes, independent artists do not receive the full royalties they deserve.

Furthermore, even though conventional talent search shows are an avenue for gaining industry acclaim and attention, they are not always the optimal way for independent artists to “break into” the music industry. Talent search shows often have a plurality of artists competing for a single record deal. The publicity that the competing artists achieve is sometimes marginalized due this limited prize system.

There are multiple patents, which are herein incorporated by reference for their supportive teachings, which teach of marketing of art, artists, actors, services, etc., which are as follows:

U.S. Pat. No. 8,521,601, by Lyren et al., issued Aug. 27, 2013, teaches of a marketing and selling feature length movies over networks.

U.S. Pat. No. 8,521,601, by Camelio, issued Feb. 8, 2011, teaches of a Methods and apparatuses for financing and marketing a creative work.

U.S. Pat. No. 7,308,413, by Tota et al., issued Dec. 11, 2007, teaches of a process for creating edia content based upon submissions.

U.S. Pat. No. 7,263,504, by Galai et al., issued Aug. 28, 2007, teaches of a diversification of risk for artists and investors.

It is therefore an objective of the present invention to overcome the aforementioned problems. The invention is a talent show system to aid independent artists in gaining publicity. There will be an increased royalty system, a plurality of winners, with a world tour intended to increase publicity and sales.

The invention is aimed at major networks, independent artists, viewers, iTunes, we are making starz and performing rights organizations such as BMI, SESAC, ASCAP. Any company can license the artists' original music without limit.

### SUMMARY OF THE INVENTION

The presented invention is a business methodology for a talent search television show. As opposed to conventional shows of a similar type, there are a plurality of winners, not just one. Furthermore, competing artists are subdivided into genres and judged separately from other genres, as opposed to artists from multiple genres competing for a single prize. Notably, this show is the first to include hip hop as a genre. The artists can gain royalties off their own songs. All artists competing on the show will earn money from mp3 sales of their original music; the sales come from viewers that purchase their song. Notably, the invention's system is designed so the artists would receive a larger percentage of the royalties than they would receive from a standard record deal or contract.

Notably, the show's prize itself is different from ordinary talent search shows. In conventional talent search shows, the prize is often a single record deal, earnable by a single winner. In the invention's system, the prize is a worldwide tour, earnable by a plurality of winners, five for each music genre. In the tour, the grand prize winner would be the headliner while the other winners would be the opening act. This invention would allow the artists greater publicity than standard talent search shows while earning increased royalties in the process.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty that characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 illustrates a flow chart of the operation of the illustrated invention.

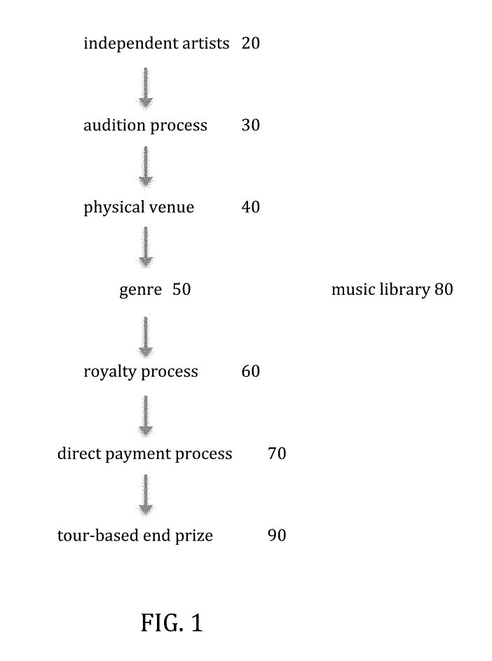

### DETAIL DESCRIPTIONS OF THE ILLUSTRATED INVENTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

Business models and methodologies can vary between embodiments, and exact figures can be adjusted to compensate for changing markets and economic changes. Any statistical figures cited are not intended to be considered fixed figures. The exact numbers can and will be adjusted to accommodate for market fluctuations, while maintaining the same functionality of the system.

In the present invention, the talent search show comprises of: “independent” artists who are contestants, the audition sub-process, the actual physical venue, subdivision by genre, a royalty sub-process that grants higher than normal royalties to the artists, a music library, and a tour-based end prize. Some of these sub-processes/components contain other sub-processes which will be detailed later.

The first major component/sub-process is the group of independent artists 20. These artists are the contestants in the show. They enter the show according to legal guidelines for age, consent, intellectual property, and any other pertinent legal restrictions. This may be via online entry, paper form, or other means. The artists do not necessarily have to be able to write their own music or have an associate who writes music for them. Music will be made available in the music library, discussed later.

The next major component/sub-process is the audition sub-process 30. This itself comprises of an online website for mp3 auditions, and all related paraphernalia and industry-standard audition procedures. An actual physical venue may be needed for certain auditions. The venue is discussed next.

The next major component/sub-process is the actual physical venue 40. This location must adhere to all local, state, and federal safety regulations and laws. This venue hosts the majority of physical activities related to the show. For the purposes of this disclosure, the venue is defined as comprising all industry-standard equipment and personnel necessary on-site for performances and pertinent televised media.

The next major sub-process is subdivision by genre 50. In conventional talent contest systems, contestants from all genres compete against each other. In the invention's system, the contestants compete only within their own genre. In the preferred embodiment, there are five genres. These genres in the preferred embodiment are country, R&B/Pop, alternative rock, gospel/Christian, and notably, hip-hop. This is important because traditionally hip hop is not a genre included in talent search shows. Future or alternative embodiments of the invention may include other, additional genres or fewer genres, according to changing industry needs. The invention is not limited by the number or type of genres.

The next major sub-process is the royalty sub-process 60. Royalties will be allocated according to standards set by performing rights organizations (PROs). According to the Songtrust music publishing glossary, PROs are “societies responsible for collecting income on behalf of songwriters and music publishers when a song is publicly broadcast.” That states that PROs track down money for the artists when their music is played on television and AM/FM airwaves, through internet radio services like Pandora, at a club, inside a restaurant, at a concert, or publicly broadcast in some other fashion. These establishments and stations pay fees to PROs, who in turn pay their registered songwriters. Further details on the royalty sub-process are discussed in later sections. Notably, this royalty sub-process also includes a direct payment sub-process.

The next major sub-process is the direct payment sub-process 70, part of the royalty sub-process. This system would allow the artists to make money from the show's viewers who purchase the artists' songs. There are potentially millions of viewers who watch the invention's show. In addition, there are a multitude of web sites that specialize in selling music from independent artists. Viewers will be able to buy artists' songs from the comfort of their own home simply by making a purchase on the web site.

Here is a hypothetical scenario of the aforementioned direct payment. In this example, 1 million viewers are watching the show. 20,000 people decide to buy that particular song from the currently performing artist at a rate of $0.99 each. The said artist would make $ 19,800.00 to be split with the music publisher off a single episode of the show, which is a significant amount of money. This format repeats itself for each independent artist that is on the show and the longer artists stay on the show, the more money they can make.

The next major sub-process is the music library 80. To reiterate, the show is not limited to only musicians who either write their own material or know someone that can write material on their behalf. The music library is a repository where original music will be available for those artists that do not have original music. The artists can submit any song for consideration in the competition. If the artist is chosen to be the one of the 15 contestants, they can choose music from the library. In the invention's preferred embodiment, the fee is 100.00 per song that they will use. The publisher will receive 50% of the fee and the writer will receive the other 50%. If this artist is a winner in the show and goes on the tour, the writer, publisher, and musician will receive percentages off of the tour. Additionally, the writer and music publisher will receive a percentage off of mp3 sales. The exact percentages may vary between embodiments and will be adjusted according to industry changes.

The final major sub-process of the invention is a tour-based end prize 90. In conventional talent search shows, a plurality of artists compete to be the sole winner. The prize is a single record deal in such conventional systems.

By contrast, in the invention's system, all contestants are winners because they receive some form of royalties. One would be the grand prize winner, and the others are regular winners. All winners of all types would go on tour. In the invention's preferred embodiment, the grand prize winner would be the headliner while the other 4 would be the opening act. In this manner, a greater number of artists would receive publicity and be given a chance to “make it big” in the music industry.

Herein follows the details in regards to royalty payments and overall business methodology for the invention's preferred embodiment. Exact figures may vary between embodiments and are not fixed. The figures shown are just an example, and may be adjusted for ongoing circumstances while still keeping with the functionality of the invention. Notably, the following statistics do not include merchandise sales, CD sales, travel commission, YouTube or other social media royalties, publishing, royalties from the actual shows, theme songs, credits, etc.
Royalties/Payments (company/artists)
CD Sells (50/50)
Ticket Sells (70/30)
Merchandise Sells (50/50)
Airing of Show(s)
Publishing (100/0)
Commission (Travel Co.) (100/0)
YouTube viewings
website membership (100/0)
Etc.
50 states
X 20,000 tickets per state
X $35.00 per ticket
X 5 tour buses (genres)
$175,000,000.00 (summer show)
+$175,000,000.00 (spring)
$350,000,000.00 (total in USA)
X 2.5 $875,000,000.00 (Overseas (fall) which is 350,000,000×2.5
$875,000,000.00 (Overseas (spring) since the overseas market is larger than the domestic
USA, figures are multiplied it by 2.5
Grand total for the year $2,100,000,000.00
Possible percentages 70/30
Companies involved divide $1,470,000,000.00
Artists divide $630,000,000.00 (divide by 50 artists if done twice a year)
Each artist gets $12,670,000.00 minus expenses

Herein follows a summary of the interaction of the major components/sub-processes of the invention.

First, the independent artists 20 enter the system as contestants. They enter according to the legal constraints for age, consent, intellectual property, and any other pertinent legal restrictions.

Next, they undergo the audition sub-process 30, which comprises of an online website for mp3 auditions and all necessary paraphernalia.

Next, is the actual physical venue 40. The actual physical venue may be needed for certain auditions and will be needed for the actual show.

Next, is the subdivision by genre 50. In the invention's system, the contestants compete only within their own music genre, instead of contestants from all genres competing against each other.

Next is the royalty sub-process 60 with a constituent direct payment sub-process 70. These allow for a higher royalty rate for the show's artists.

Finally, after the aforementioned sub-processes have been run through, is the awarding of the prize. The world tour is the end prize. There will be a plurality of winners as opposed to just one. All winners would go on tour. The grand prize winner would be the headliner while the others would be the opening acts.

Although the invention has been explained in relation to its preferred embodiment, it is to be understood that many other possible modifications and variations can be made without departing from the spirit and scope of the invention. Obvious changes, modifications, and substitutions may be made by those skilled in the art to achieve the same purpose the invention. The exemplary embodiments are merely examples and are not intended to limit the scope of the invention. It is intended that the present invention cover all other embodiments that are within the scope of the descriptions and their equivalents.

I/We claim as follows:

1. A method of marketing independent artists from a pool of contestants, comprising the following steps:
a. collect information from contestants including age, consent, and intellectual property rights;
b. undergo an audition process, for selected contestants, which comprises an online website to allow downloading of auditions, and selecting a best of downloaded auditions contestants;
c. conducting actual physical venue auditions for the best of downloaded auditions contestants;
d. separating the best of downloaded auditions contestants into genre, whereby the contestants compete only within their own genre, instead of contestants from all genres competing against each other; and
e. paying a royalty to each contestant with a constituent direct payment that allows for a higher royalty rate for the show's contestants.
